(19) United States
(12) Patent Application Publication
(10) Pub. No.: US 2025/0067080 A1
(43) Pub. Date: Feb. 27, 2025

(54) RECREATIONAL VEHICLE AND POP-UP ROOF

(71) Applicant: Thor Tech, Inc., Elkhart, IN (US)

(72) Inventors: Alexander Kasteleiner, Greifenberg (DE); Jens Kromer, Achern (DE); Olaf Sackers, Sulz (DE)

(73) Assignee: Thor Tech, Inc., Elkhart, IN (US)

(21) Appl. No.: 18/814,008

(22) Filed: Aug. 23, 2024

(30) Foreign Application Priority Data
Aug. 25, 2023 (DE) 10 2023 122 939.7

(51) Int. Cl. E04H 15/06; B60R 3/00; E04H 15/20; E04H 15/56

(52) U.S. Cl. CPC E04H 15/06; B60R 3/005; E04H 15/20; E04H 15/56; E04H 2015/201

(57) ABSTRACT

Pop-up roof for leisure vehicles, in particular motorhomes and/or camper vans and/or leisure vehicles based on high-roof station wagons, with a floor which, in an assembled state, can be supported at least indirectly on a roof of the recreational vehicle, wherein, in the assembled state, a part of the floor stands over an edge of the roof, and wherein a ladder can be fastened to the floor for an ascent into an interior space provided in the assembled state. It is proposed that a length of the ladder is adjustable, that the ladder can be locked at an adjusted length and that the part of the floor can be supported by the locked ladder. Furthermore, a recreational vehicle with such a pop-up roof is disclosed.

### BACKGROUND

The invention relates to a recreational vehicle, in particular a motorhome and/or a campervan. In particular, the invention relates to a vehicle based on a high roof recreational vehicle.

A roof tent for vehicles is known from DE 10 2021 106 143 A1. The known roof tent comprises a first (upper) cover section consisting of a waterproof upper shell and a second (lower) cover section which comprises a bottom member identical in size to the upper cover portion and including at least one outer hinge connecting portion rotatably connecting the first cover portion and the second cover portion up to 180° and a tent portion coupled to the first cover portion and the second cover portion, wherein the lower cover portion is connected to the first cover portion and the second cover portion in such a manner that the lower cover portion can be rotated up to 180° and is intended to be permanently mounted on a roof of a support structure. Furthermore, in folding mode, the first cover section can be closed in a form-fitting manner with the second cover section without additional waterproof sections. In the known roof tent, a hard shell is provided and a doubling of the lying surface is achieved. With the known roof tent, supports are provided to stabilize the upper cover element in unfolded mode. An attachment option for an opening aid is mandatory on the top of the upper cover section. A ladder belonging to the tent can provide this opening aid.

The roof tent known from DE 10 2021 106 143 A1 has the disadvantage that an additional hard shell is required for the lying surface, resulting in a complex design. In particular, a hinge mechanism is required. Lying across the hinge mechanism is uncomfortable if the additional hard shell is not optimally aligned. Furthermore, reclining along the hinge mechanism requires a correspondingly long roof surface.

EP 3 464 755 A1 describes a vehicle with a roof tent comprising a supporting frame, a tent skin supported on the supporting frame and a tent floor.

In the known tent, the tent floor is formed by an inflatable body which is plate-like in the inflated state, the top and bottom layers of which consist of a flexible material and are connected to one another by a plurality of connecting threads or connecting fibers and, in the inflated state, are held in a maximum normal distance from each other.

The roof tent known from EP 3 464 755 A1 has the disadvantage that the design of the floor layer requires a special material. Furthermore, in the event of a pressure drop in the floor layer, the stability of the roof tent is no longer guaranteed.

### BRIEF SUMMARY

The object of the invention is to provide a pop-up roof for a recreational vehicle and a recreational vehicle which are improved. In particular, it is a task of the invention to provide a pop-up roof for a recreational vehicle and a Recreational vehicle, in which a good lying comfort can be achieved even with a limited roof area, in particular a short roof area, whereby a cost-effective design and/or a design with less complexity is possible.

The problem is solved by a pop-up roof with the features of independent patent claim 1 and by a leisure vehicle with the features of patent claim 11. Advantageous further developments of the invention are given in the subclaims.

The problem is solved by a pop-up roof for leisure vehicles, in particular motorhomes and/or camper vans and/or leisure vehicles based on high-roof station wagons, with a floor which, in a raised state, can be supported at least indirectly on a roof of the leisure vehicle, wherein, in the raised state, a part of the floor protrudes over an edge of the roof, wherein a ladder for climbing into an interior space provided in the assembled state can be fastened to the floor, wherein a length of the ladder is adjustable, wherein the ladder can be locked at an adjusted length and wherein the part of the floor can be supported by the locked ladder.

Furthermore, the problem is solved by a leisure vehicle, in particular a motorhome and/or a campervan and/or a leisure vehicle based on a high-roof station wagon, with such a pop-up roof.

The roof of the recreational vehicle is not necessarily a component of the pop-up roof according to the invention. In particular, the pop-up roof can also be manufactured and sold independently of a recreational vehicle. The ladder can be used for the function of a support as a folding ladder or as a single ladder or extendable ladder. The ladder can be locked in place as a support.

It is advantageous for the ladder to stand on a surface next to the recreational vehicle when it is set up and for the part of the floor above the locked ladder to be connected to the ground. By adjusting the length, it is possible to adapt to a non-flat surface.

It is advantageous that the ladder is designed as a variable and/or extendable ladder. For example, push-in elements with a ball head can be used in suitable holes so that adjustment in steps is possible. Additionally or alternatively, at least one locking device can be provided, which clamps a longitudinal profile, for example, in order to lock the ladder at the set length.

It is advantageous that a roof shell is provided and that, when assembled, the roof shell at least partially forms a rear wall arranged at least approximately along one side of the vehicle, which delimits the interior. This ensures a high level of stability and at the same time the weight of the roof shell can be supported by the roof of the leisure vehicle.

It is advantageous that an access opening to the interior is provided and that the ladder is used to climb through the access opening into the interior and that the access opening is arranged opposite the rear wall formed by the roof shell. This makes it advantageous to set up the ladder, which, transverse to a longitudinal direction of the vehicle, prevents the floor from protruding. This allows two people to sleep lengthways, for example.

It is advantageous that at least one inflatable side wall stabilization which, in the assembled state, runs at least partially along a window, in particular a mesh window. This provides additional reinforcement.

It is advantageous that the side wall stabilization is at least essentially extends over a projecting area of a side wall, which is arranged over the projecting part of the floor, and preferably at least partially over a roof area of the side wall, which is arranged over the roof of the recreational vehicle. This improves the stability of the arrangement. In particular, better stability in windy conditions can be achieved.

It is advantageous that the side wall stabilization is provided on one side wall and that a further inflatable side wall stabilization is provided, which is provided on a further side wall opposite the side wall. In particular, this enables symmetrical stabilization to be achieved.

It is advantageous that an inflatable roof-side support arch is provided, which spans side walls and a tent roof at least substantially above the roof of the leisure vehicle, and/or that an inflatable roof-remote support arch is provided, which spans side walls and a tent roof at least substantially over the projecting part of the floor of the recreational vehicle and preferably comprises an access opening in the shape of an arch. In particular, this can improve stability in the support area on and above the ladder. Furthermore, stability in the area of the roof of the recreational vehicle can be improved. The tent roof can also be significantly stabilized.

It is advantageous that the support arch on the roof side and/or the support arch away from the roof adjoin at least one inflatable side wall stabilizer at least essentially without interruption and/or are connected to at least one inflatable side wall stabilizer, e.g., an inflatable structure comprising the side wall stabilizers and the supporting arches.

Further advantages and details of the invention are described in the schematic figures.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1A leisure vehicle with a pop-up roof according to an embodiment example in a schematic, spatial representation, showing a view from the side at the front with the pop-up roof closed;

FIG. 2 the leisure vehicle shown in FIG. 1, with the pop-up roof installed;

FIG. 3 the recreational vehicle shown in FIG. 2 from the viewing direction marked III; and

FIG. 4 an interior of the assembled pop-up roof.

### DETAILED DESCRIPTION

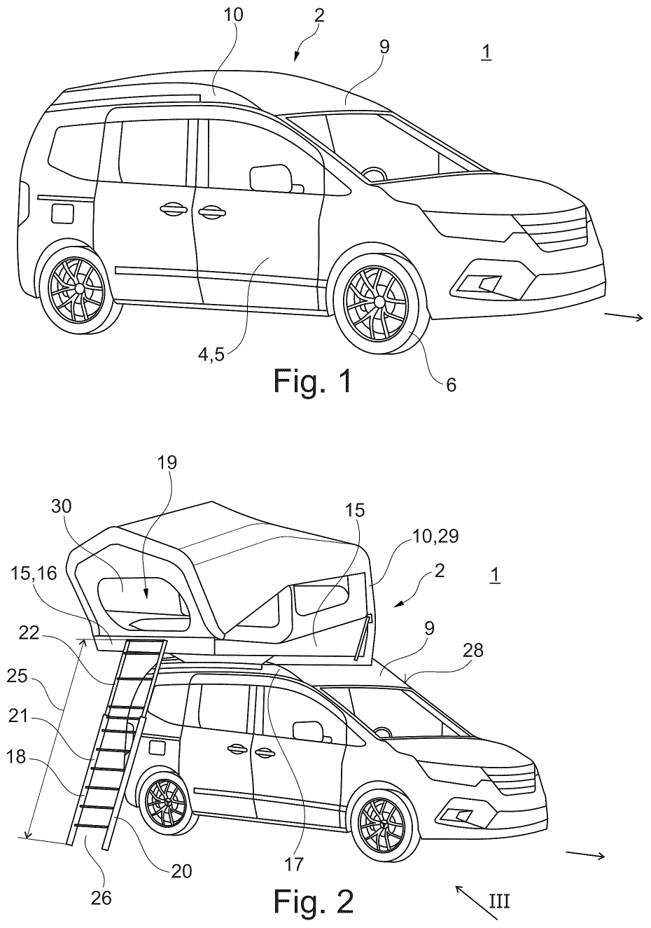

FIG. 1 shows a leisure vehicle 1 with a pop-up roof 2 according to an embodiment example in a schematic, spatial representation, whereby a view from the side at the front with the pop-up roof 2 closed is shown. The recreational vehicle 1 can be used in particular as a motorhome and/or camper van and/or be designed as a leisure vehicle 1 based on a high-roof station wagon.

The leisure vehicle 1 can be based on a base vehicle 4. In this example, the base vehicle 4 is a high-roof station wagon. This means that the leisure vehicle 1 can be manufactured with reduced production costs. In order to optimize manufacturing costs, the body 5, a chassis 6, the seats 7 of the first row and the rear bench 8 or individual seats in the rear are used in particular. The tailgate is preferably the tailgate of the base vehicle 4.

However, suitable modifications can be provided which, for example, enable a roof 9 of the recreational vehicle 1. For example, in the roof 9 roof cut-out (not shown) can be provided. The roof 9 is then closed by a roof shell 10 of the pop-up roof 2 when the pop-up roof 2 is closed. In this design example, however, no roof cut-out is required.

The roof 9 can be relatively short when viewed in a longitudinal direction 11 of the recreational vehicle 1. In particular, the roof 9 can be too short in the longitudinal direction 11 to allow an adult to lie down in the longitudinal direction 11 when stretched out. In the preferred embodiment, two people in particular can lie or sleep transversely to the longitudinal direction 11.

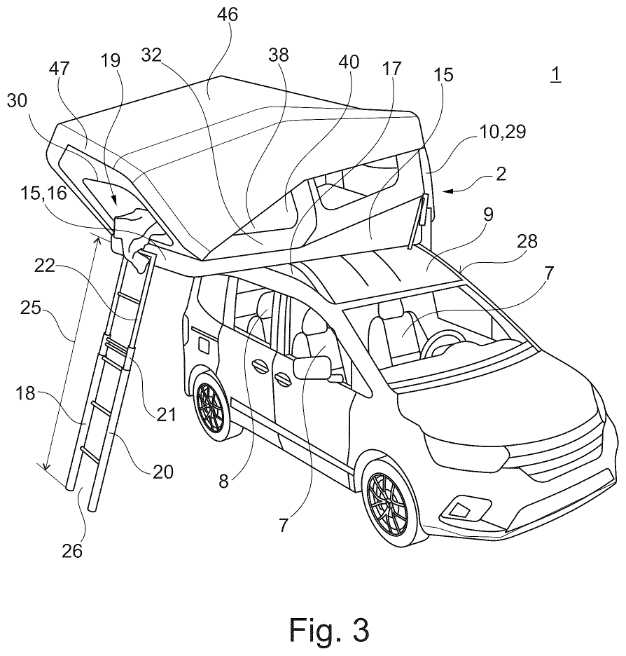

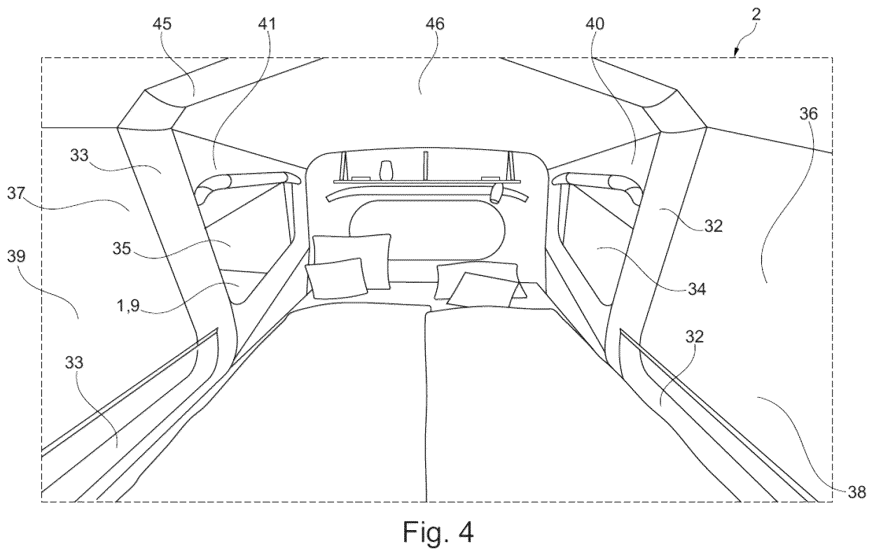

FIG. 2 shows the leisure vehicle 1 shown in FIG. 1, with the pop-up roof 2 in place. Furthermore, FIG. 3 shows the leisure vehicle 1 shown in FIG. 2 from the viewing direction marked III. FIG. 4 also shows an interior of the assembled pop-up roof 2.

The pop-up roof 2 has a floor 15 which is supported on a roof 9 of the recreational vehicle in the assembled state. Furthermore, in the assembled state, part 16 of the floor 15 protrudes beyond an edge 17 of the roof 9.

The base 15 is not necessarily self-stiffening. In particular, the floor 15 may not be self-stiffening. The floor 15 may not be supported by the floor 15 itself, but at least essentially by the ladder 18.

The pop-up roof 2 has a ladder 18, which is used to climb into an interior 19 of the pop-up roof 2. The ladder 18 is attached to the floor 15 for this purpose. In this embodiment example, the ladder 18 has several ladder parts 20, 21, 22. A length 25 of the ladder 18 can be adjusted by a user. For this purpose, in this embodiment example, the ladder parts 20, 21, 22, which are partially pushed into one another, can be adjusted, can be pushed more or less far into each other by a user so that the length 25 can be changed. The ladder 18 can then be locked at the set length 25 by the user. The ladder 18 can be retracted and extended variably and/or in steps. This enables convenient handling.

The pop-up roof 2 has a ladder 18, which is used to climb into an interior 19 of the pop-up roof 2. The ladder 18 is attached to the floor 15 for this purpose. In this embodiment example, the ladder 18 has several ladder parts 20, 21, 22. A length 25 of the ladder 18 can be adjusted by a user. For this purpose, in this embodiment example, the ladder parts 20, 21, 22, which are partially pushed into one another, can be adjusted, 30 can be pushed more or less far into each other by a user so that the length 25 can be changed. The ladder 18 can then be locked at the set length 25 by the user. The ladder 18 can be retracted and extended variably and/or in steps. This enables convenient handling.

In the assembled state, the ladder 18 stands on a base 26 next to the recreational vehicle 1. The ladder 18, which is attached to the floor 15, then supports the part 16 of the floor 15 on the base 26 via the locked ladder 18. Thus, the ladder 18 serves on the one hand for climbing up and on the other hand for supporting the Bodens 15.

When folded up, the roof shell 10 forms a rear wall 29 arranged along one side 28 of the vehicle. The rear wall delimits the interior 19 of the pop-up roof 2. An access opening 30 is provided above the part 16 of the floor 15 in the roof. Access via the ladder 18 leads through the access opening 30 into the interior 19. The access opening 30 is opposite the rear wall 29 formed by the roof shell 10.

Furthermore, inflatable side wall stabilizers 32, 33 are provided, which are used in the assembled state run along windows 34, 35, which can be designed as mesh windows 34, 35. The side wall stabilizers 32, 33 extend over projecting regions 38, 39 of the side walls 36, 37, which are arranged over the projecting part 16 of the floor 15. In addition, the side wall stabilizers 32, 33 extend partially over roof areas 40, 41 of the Side walls 36, 37, which are arranged above the roof 9 of the recreational vehicle 1.

An inflatable roof-side support arch 45 is also provided. The roof-side support arch 45 spans the side walls 36, 37 and a tent roof 46 of the pop-up roof 2 above the roof 9 of the recreational vehicle 1. Furthermore, a inflatable remote roof support arch 47 is provided. The off-roof support arch 47 spans the side walls 36, 37 and the tent roof 46 over the projecting part 16 of the floor 15 of the recreational vehicle 1. In this embodiment example, the support arch remote from the roof is arranged and designed such that it surrounds the access opening 30 in the shape of an arch.

The side wall stabilizers 32, 33 stabilize the side walls 36, 37 in the Transition from the respective roof area 40, 41 to the projecting area 38, 39.

The roof-side supporting arch 45 and the supporting arch 47 away from the roof as well as the inflatable sidewall stabilizers 32, 33 can be equipped with a total chamber or subdivided with several chambers. Separate designs can also be realized, with preferably no significant distance between the individual chambers. Furthermore, the roof-side supporting arch 45 and/or the roof-remote supporting arch 47 and/or the inflatable Side wall stabilizers 32, 33 can also be designed as self-stiffening elements.

The invention is not limited to the embodiments described.

1. A pop-up roof for recreational vehicles with a floor which, in a built-up state, rests on a roof of the recreational vehicle wherein, in the assembled state, a part of the floor protrudes over an edge of the roof, wherein a ladder can be fastened to the floor for an ascent into an interior provided in the assembled state, and wherein:
a length of the ladder is adjustable;
the ladder can be locked at an adjusted length; and
part of the base is supported by the locked ladder.

2. The pop-up roof according to claim 1, wherein the ladder, in the assembled state, stands on a base next to the recreational vehicle, and the part of the floor can be supported on the base via the locked ladder.

3. The pop-up roof according to claim 1, wherein the ladder is designed as a ladder that can be extended variably or in steps.

4. The pop-up roof according to claim 1, wherein a roof shell is provided and the roof shell, in the assembled state, at least partially forms a rear wall which is arranged at least approximately along one side of the vehicle and which forms the interior of the vehicle.

5. The pop-up roof according to claim 4, wherein an access opening is provided in the interior, the ascent via the ladder through the access opening into the interior, and the access opening is arranged opposite the rear wall formed by the roof shell.

6. The pop-up roof according to claim 1, wherein at least one inflatable side wall stabilizer is provided which, in the assembled state, runs at least partially along a mesh window.

7. The pop-up roof according to claim 1, wherein the side wall stabilization extends at least substantially over a projecting region of a side wall, which extends over the projecting part of the floor, and extends at least partially over a roof region of the side wall, which is arranged above the roof of the recreational vehicle.

8. The pop-up roof according to claim 6, wherein the side wall stabilizer is provided on one side wall and a further inflatable side wall stabilizer is provided, which is provided on a further side wall opposite the side wall.

9. The pop-up roof according to claim 1, wherein an inflatable roof-side support arch is provided, which has side walls and a tent roof, and an inflatable support arch remote from the roof is provided, which spans side walls and a tent roof at least substantially above the projecting part of the floor of the recreational vehicle and has an access opening in the shape of an arc.

10. The pop-up roof according to claim 9, wherein the support arch on the roof side and the support arch remote from the roof is connected at least substantially without interruption to at least one inflatable side wall stabilization and with at least one inflatable side wall stabilizer.

11. A recreational vehicle with a pop-up roof according to claim 1.
